(19) United States
(12) Patent Application Publication
(10) Pub. No.: US 2010/0025226 A1
(43) Pub. Date: Feb. 4, 2010

(54) Configurations for Chlorine Dioxide Production

(76) Inventor: Joseph Callerame, Lake Havasu City, AZ (US)

Correspondence Address: MILLER, CANFIELD, PADDOCK AND STONE, 277 SOUTH ROSE STREET, SUITE 5000, KALAMAZOO, MI, 49007, US

(21) Appl. No.: 12/301,476

(22) PCT Filed: May 21, 2007
(86) PCT No.: PCT/US07/69365

§ 371 Date: Apr. 23, 2009

Related U.S. Application Data
(60) Provisional application No. 60/747,710, filed on May 19, 2006.
(60) Provisional application No. 60/747,705, filed on May 19, 2006.
(60) Provisional application No. 60/805,842, filed on Jun. 26, 2006.
(60) Provisional application No. 60/806,874, filed on Jul. 10, 2006.
(60) Provisional application No. 60/823,952, filed on Aug. 30, 2006.

(51) Int. Cl. C01B 7/01; B01J 19/12

(52) U.S. Cl. 204/157.48; 422/186.3

(57) ABSTRACT

Methods and compositions to produce chlorine dioxide by reacting one or more reactants under the presence of polarized ultraviolet radiation, an electromagnetic field (EMF), successive chambers, and coiled configurations are disclosed. Polarized ultraviolet radiation and EMF favor the formation of chlorine dioxide and reduces the reversible reactions.

This application claims priority to U.S. Provisional Patent Application No. 60/747,705, filed May 19, 2006, U.S. Provisional Patent Application No. 60/747,710, filed May 19, 2006, U.S. Provisional Patent Application No. 60/805,842, filed Jun. 26, 2006, U.S. Provisional Patent Application No. 60/806,874, filed Jul. 10, 2006, and U.S. Provisional Patent Application Ser. No. 60/823,952, filed Aug. 30, 2006, the disclosures of each of which are herein incorporated by reference.

### BACKGROUND

Chlorine dioxide is of considerable industrial importance and has found use as a disinfectant and in the bleaching of wood pulp, fats, oils and flour, and more recently for the sterilization of anthrax. Generally, chlorine dioxide is used as a bleaching agent and for removing tastes and odors from water and other liquids. More recently, it has been used as an anti-pollutant for disinfecting drinking water.

For several of the established uses of chlorine dioxide, it is desirable to produce the gas in situ so that the chlorine dioxide, upon formation, can be directly put to use either in gaseous form or, after absorption, in the form of an aqueous solution. In many instances, the use of chlorine dioxide solution rather than in the gaseous form is preferred. Chlorine dioxide is absorbed in water and forms chlorous acid, from which the gas can be readily expelled by heating. The presence of chlorous acid in an aqueous solution indicates a reaction of chlorine dioxide with water.

Several processes have previously been proposed for producing chlorine dioxide. U.S. Pat. Nos. 3,648,437, 3,695,839, 3,828,097, 4,877,500, 4,874,489 and 3,754,079, are directed to the production of chlorine dioxide or chlorous acid from which the chlorine dioxide can be expelled.

### SUMMARY

Chlorine dioxide is produced by subjecting a mixture of oxygen gas and chlorine gas to polarized ultraviolet radiation. In an embodiment, the reaction to produce chlorine dioxide is carried out in a reaction space devoid of nitrogen. The presence of nitrogen does not prevent the formation of the chlorine dioxide, but nitrogenous chlorine-containing compounds are potentially formed as by-products. This lowers the yield of chlorine dioxide and is, of course, undesired. The yield of chlorine dioxide obtained by exposing the chlorine-oxygen gas mixture to ultraviolet radiation is a function of the exposure time, the intensity of the radiation and the ratio of the reactants.

The inventive method described herein involves the surprising effects achieved by exposing the reactants to a polarized radiation at from about 200-400 nm, preferably 240-360 nm wavelength. The wavelength can be varied about these parameters, however, without limiting the scope of the invention, in one embodiment, increased ClO₂ production is achieved when the polarized UV radiation is held constant at about 254 nanometers. The polarized radiation, such as, for example, polarized UV light may be about 75% polarized or about 80% polarized or about 95% polarized or about 100% polarized. Lower or higher percent polarized light can be used depending on the yield of chlorine dioxide produced. The angle of polarized light may also vary relative to unpolarized light source. The intensity of the radiation can vary from about 1,000 microwatts/sq. cm to about 60,000 microwatts/sq. cm.

Methods disclosed herein can be carried out in situ and ex situ. Furthermore, the chlorine dioxide formed need not be separated from the reaction mixture; however, the entire reaction mixture, including the chlorine dioxide formed, may in most instances, be used as a whole since the other components of the reaction do not exert a detrimental influence on the application properties. Thus, the chlorine dioxide containing reaction product obtained as a result of the polarized radiation may be expelled from the reaction space and conveyed to a place of use, or, if desired, after completion of the reaction, the reaction mixture may be passed through water to form dissolved chlorine dioxide or chlorous acid.

One or more UV lamps can be positioned such that there exists a time interval between irradiations. The one or more UV lamps can be turned off and on such that there exists a specific period during which there is no irradiation. This cycle of irradiation followed by a pause, enhances the yield of chlorine dioxide. This cyclical irradiation pattern is established by configuring one or more lamps serially or in parallel configuration, such that an incoming flow of precursor is exposed to the one or more lamps in a serial fashion with time intervals or by turning on and off the UV lamps in a periodic mode.

Chlorine dioxide (ClO₂) production is enhanced by use of an electromagnetic field (EMF) or electromotive force. In an aspect, the electromagnetic field is present during ultraviolet (UV) radiation-based production of chlorine dioxide. The EMF is believed to favor the reaction that results in the formation chlorine dioxide from the starting materials, e.g. chlorine and oxygen.

Simultaneous generation of ClO₂ and ozone enhance the disinfection/sterilization capacity. Coiled configurations to simultaneously carry unclean material and reaction mixture for chlorine dioxide and ozone generation are disclosed. Powerful ultraviolet lamp having an irradiation intensity of about 50-80 watts or about 25-100 watts and having a wavelength in the range of about 254 nm plus or minus 100 nm are suitable. Upon irradiation of the chlorite solution, the chlorite is converted to ClO₂. Other features such as a polarized light source, additional EMF, reduced scattering, coiled configuration of the reactor, multiple UV lamps, successive chambers can also be present.

An outer, larger diameter coil contains material to be sterilized or disinfected and an inner, smaller diameter coil produces ClO₂ that can further sterilize/disinfect the desired material. All the coils used in this embodiment are non-reactive to chlorine dioxide, ozone, precursors and allow UV penetration. Suitable material includes Teflon and quartz tubings or a combination thereof. One or more UV lamps may be used. Any suitable number of lamps can be used.

The irradiation from the UV lamps penetrates the reactor surface that is made of a UV-permissive material e.g., Teflon tubing or coil and disinfect an adjacent coil that is placed within the outer coil or in close proximity to the outer coil. UV light penetrates the inner coil, produces chlorine dioxide from chlorite and further penetrates the outer coil and disinfect circulating dirty material. Air is passed over the UV lamps to cool the lamps. The UV irradiation generates ozone and this ozone can be recirculated or reintroduced into the outer coil carrying the dirty water for further disinfection/sterilization. The chlorine dioxide produced from the inner coil is also dosed into outer coil carrying the dirty water for further disinfection/sterilization. Further, the UV light from the UV lamps is powerful enough to directly sterilize the dirty water in the outer coil. The additional sterilization effect by ozone can be used to reduce the demand and consumption of ClO₂. UV-permissive tubing maximizes the synergistic disinfection effects of ClO₂ and ozone and direct sterilization effect of UV can also aid in biocide effectiveness.

The UV-lamp in the reaction chamber may be coated with Teflon or polytetrafluoroethylene (PTFE) or any suitable non-corrosive layer to enhance the life and the efficiency of the lamp and to minimize undesirable salt deposits.

The synergistic effects of ClO₂ and ozone along with the direct sterilization by UV results in an enhanced and effective disinfection process. In addition, the effective disinfection is achieved in a single unit set-up without the hassle of transporting ClO₂ to a water treatment facility or any other distant location. Therefore, this combination ClO₂-ozone generator saves energy, cost, space, set-up time, and provides advantageous disinfection capability.

A system for chlorine dioxide production includes:
a reaction chamber that includes one or more successive chambers to receive one or more reactants to form chlorine dioxide;
an ultraviolet radiation source position either within the reaction chamber or adjacent to the reaction chamber;
a polarizer to polarize the UV radiation, the polarizer positioned to allow the UV radiation from the UV source to pass through the polarizer; and
an exit member to retrieve the chlorine dioxide produced in the reaction chamber.

A system for chlorine dioxide production includes:
a reaction chamber comprising one or more successive chambers to receive one or more reactants to form chlorine dioxide;
an ultraviolet radiation source positioned either within the reaction chamber or adjacent to the reaction chamber; and
a source for an electromagnetic field to accelerate the formation of chlorine dioxide.

The sample chamber may include a coiled configuration.

A device for chlorine dioxide production includes:
a reaction chamber comprising one or more successive chambers to receive one or more reactants to form chlorine dioxide and the reaction chamber is adjacent to one or more of the following members:
an ultraviolet radiation source positioned either within the reaction chamber or adjacent to the reaction chamber;
a polarizer to polarize the UV radiation, the polarizer positioned to allow the UV radiation from the UV source to pass through the polarizer; and
a source for an electromagnetic field to accelerate the formation of chlorine dioxide.

A method of producing chlorine dioxide, the method includes the steps of:
introducing one or more reactants for chlorine dioxide production into a reaction chamber to form a reaction mixture; and
subjecting the reaction mixture to one or more of the treatments comprising:
   (a) exposing the reaction mixture to a polarized ultraviolet radiation;
   (b) providing an electromotive field (EMF); and
   (c) performing the reaction in one or more successive chambers; to produce chlorine dioxide.

The reaction mixture may include chlorine gas and oxygen gas. The reaction mixture may include a reactant selected from the group of NaClO₂, NaClO₃, HClO₂, and HClO₃.

### BRIEF DESCRIPTION OF THE DRAWING

FIG. 1 shows a schematic illustration of an apparatus for producing chlorine dioxide.

FIG. 2 shows an atomizer configuration for producing a mist for generation of chlorine dioxide.

FIG. 3 shows schematic and actual illustration of sources of irradiation (e.g., UV lamps) in a cascade configuration, wherein two or more lamps are arranged successively.

FIG. 4 shows a coiled configuration of an embodiment of a ClO₂ generation device with cascading bulb arrangement, wherein the reactive material is circulated inside a coil that surrounds an irradiation source. Optionally, as shown in the illustrative embodiment a cooling member is also positioned circumferentially to enclose the irradiation source, wherein air or any suitable cooling liquid is circulated.

FIG. 5 shows a coiled configuration illustrating an embodiment of a ClO₂ generation device in the absence of a separate cooling member.

FIG. 6 shows an up and down arrangement of the coiled configuration illustrating an embodiment of a ClO₂ generation device.

FIG. 7 shows a schematic illustration of an embodiment of a ClO₂ generation device of coiled configuration, wherein a provision for chlorate discharge is included.

FIG. 8 shows a Venturi effect, wherein passing a stream of air in a chamber draws ClO₂ out of the storage or removal of ClO₂.

FIG. 9 shows an illustration of a mechanism for removing chlorine dioxide during production to enhance the efficiency by reducing the scattering effect in a UV-based ClO₂ generation device. CO2 can also be used as a bubbling agent, which leads to lowering of pH and formation of chlorous and chloric acid, in turn resulting in the formation of chlorine dioxide.

FIG. 10 shows that the chlorine dioxide conversion increases by application of additional EMF (A) compared to the absence of additional EMF (B) and an instrument used for generating EMF (C). Application of EMF reduces the reversion of chlorine dioxide to its constituents upon UV exposure.

FIG. 11 shows an experimental set-up showing the application of EMF for a chlorite-based ClO₂ generation device (A) and the production of ClO₂ as indicated by bubbles with respect to the color of the indicators (B). 25% chlorite solution was irradiated in 2 one-ounce Teflon™ beakers and one of them had a charge across the fluid.

FIG. 12 shows a perspective schematic illustration of an embodiment of an apparatus for producing chlorine dioxide (A); a perspective schematic illustration of a side-view of the apparatus for producing chlorine dioxide and ozone simultaneously (B); and a top cross-sectional view of the apparatus for producing chlorine dioxide and ozone simultaneously (C).

FIG. 13 shows a synergistic configuration in which the UV source is directly submerged in the reaction mixture.

FIG. 14 is coil configuration embodiment of FIG. 13.

### DETAILED DESCRIPTION OF THE DRAWING

Some of the traditional mechanisms for producing ClO2 include, for example,

In a laboratory, ClO₂ is prepared by oxidation of sodium chlorite:

2NaClO₂+Cl₂→2ClO₂+2NaCl

ClO2 can also be produced by reducing sodium chlorate in a strong acid solution with a suitable reducing agent (for example, hydrogen peroxide, sulfur dioxide, or hydrochloric acid):

2ClO₃⁻+2Cl⁻+4H+→2ClO₂+Cl₂+2H₂O

Sodium chlorate reaction with hydrochloric acid:

2NaClO₃+4HCl→2NaCl+2ClO₂+Cl₂+2H₂O

Traditionally, chlorine dioxide for disinfection applications has been made by one of three methods using sodium chlorite or the sodium chlorite-hypochlorite method:

2NaClO₂+2HCl+NaOCl→2ClO₂+3NaCl+H₂O

or the sodium chlorite-hydrochloric acid method:

5NaClO₂+4HCl→5NaCl+4ClO₂

Chlorine dioxide can also be produced by electrolysis of a chlorite solution:

2NaClO₂+2H₂O→2ClO₂+2NaOH+H₂

High purity chlorine dioxide gas can be produced by the Gas:Solid method, which reacts dilute chlorine gas with solid sodium chlorite.

2NaClO₂+Cl₂→2ClO₂+2NaCl

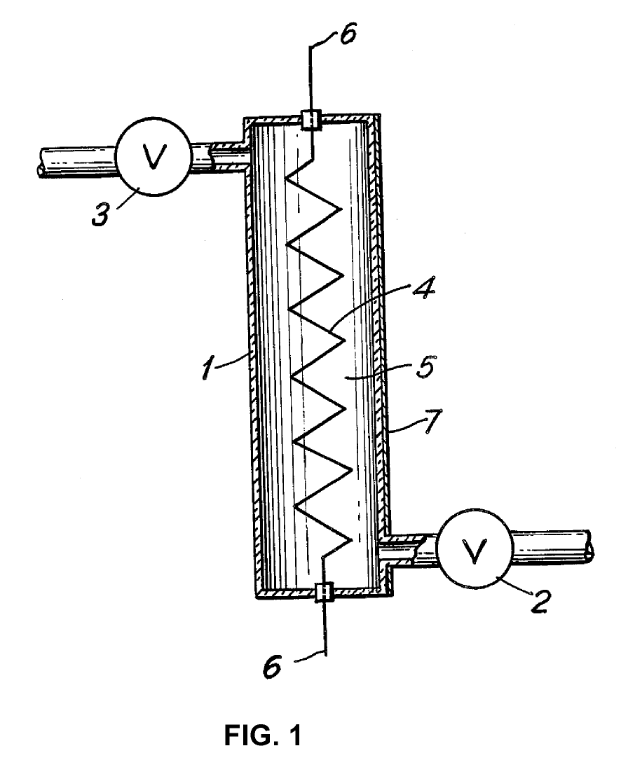

The chlorine dioxide production process may be carried out in a reactor type illustrated FIG. 1. The reactor includes a tubular vessel 1 having a valve-controlled bottom inlet 2 and a valve-controlled top exit 3. The tubular vessel is made of glass, titanium or a steel alloy, such as known under the name Hastalloy C or any suitable material. An ultraviolet radiation source, such as, one or several quartz lamps 4, is arranged within the space 5 defined by the tubular vessel 1. Any suitable shape of a quartz lamp or other UV radiation source is preferred. The electrical connections for the quartz lamp are diagrammatically indicated by reference numeral 6. If the wall material of the tubular vessel 1 permits polarized UV radiation to be transmitted, the UV source may be arranged outside the vessel. The UV radiation source is associated with a polarizing filter member or any suitable polarizing member. For example, the UV lamp can itself be coated or covered with polarizing filter member. Optionally, a separate polarizing filter can be placed outside the lamp so as to permit the light emitted by the UV lamp to pass through the filter member.

In order to enhance and contain the polarized ultraviolet radiation emitted by the lamp, and if the reactor wall transmits polarized UV radiation, it may be desirable to provide a shiny reflector, such as of aluminum, at the outside of the tubular vessel 1. Such a reflector is generally indicated in the drawing by reference numeral 7. The reflector may be arranged within the reaction space if it has a surface coating resistant to the reactants.

As a general proposition, the reactor wall material should be of the polarized UV transmitting kind. If the polarized UV source is arranged outside the reactor space, but may be non-transmitting if the light source is located within the reactor space. The wall may thus be of glass, plastic, steel alloy or titanium, provided the material is resistant to the reactants. As stated, a highly polished aluminum reflector should advantageously be used to contain the intensity of the radiation in the chamber space of the reactor if the material transmits polarized UV radiation.

A polarizing screen may be a linear reflecting polarizer screen, e.g., a 90° linear polarizer that functions like a conventional absorption polarizer, except that it reflects (instead of absorbs) substantially all light that does not pass though it. The 90° reflecting polarizer screen transmits substantially all light waves polarized to 90° (i.e., “vertically” polarized light) and reflects substantially all light waves polarized to 0° (i.e., “horizontally” polarized light). Polarizer may be made of any suitable reflecting polarizing material, such as double brightness enhancement film (“DBEF”), material obtained from Minnesota Mining and Manufacturing Company (3M Inc.,).

A suitable polarizer also includes a high transmittance-high efficiency linear polarizer that has about 38% transmittance for unpolarized light. Commercial-quality film polarizers available in medium gray (25% transmission) and medium brown (22% transmission). Polarization efficiency is over 90%, preferably over 95%, and more preferably over 99%. Extinction is described generally as a polarizing filter's ability to absorb polarized light that has an orientation 90° to the polarizer's axis of polarization.

In an embodiment, reaction geometry of selected species (e.g., Cl₂ and O₂) can be controlled by using polarized light. It is possible that one of the reactants is generated in a photodissociation process. Another molecular reactant may be excited in a specific rovibrational state. For example, an attacking oxygen or a chlorine atom is generated in the photodissociation/photolysis in the UV range (e.g., about 100-400 nm, or about 200-300 nm, or about 250-280 nm; or about 280-355 nm). For example, in an embodiment, chlorine atom is formed in the photolysis of Cl₂ at 355 nm. Polarized UV excitation provides an optimal reaction geometry for the formation of ClO₂ molecule from its reacting constituents.

In an embodiment, the overall reaction of converting a precursor to ClO₂ is enhanced by irradiating the precursor (e.g., chlorite or any suitable precursor to generate chlorine dioxide) serially, wherein a specific “pause” period is maintained during which no irradiation is performed. This series of irradiation followed by a period of no irradiation (e.g., ⅕^{th} to 1/20^{th} the time for irradiation) increases the yield of chlorine dioxide. The serial irradiation or pulsing is accomplished by (i) turning on and off the one or more UV lamps with a specific time interval or by (ii) configuring a plurality of UV lamps positioned such that the incoming precursor for chlorine dioxide generation is exposed serially to the UV lamps, wherein there is a temporal and/or spatial interval between irradiations.

Without being bound by the underlying theory behind the periodic irradiation or pulsed irradiation, it is believed that each exposure to UV excites the precursor molecules (e.g., chlorite or any suitable precursor for UV-based ClO₂ generation), a photon is discharged and ClO₂ is formed by the reactions disclosed herein. The presence of ClO₂ (yellowish) may act as an interference for further UV penetration during an extended synthesis phase. Thus, the rate of ClO₂ generation may be diminished as the UV exposure continues or toward the later stages in the production. The reaction is not a linear progression, but proceeds more of a parabolic nature showing diminishing returns. A hypothetical model of the progression of ClO₂ yield with UV pulsing (solid line) and without UV pulsing (dotted line) is shown below.

By giving the irradiated solution a pause from irradiation, allows the reaction to settle (e.g., the overall entropy goes down and the yellow color decreases). This pause allows the solution to once again become “ready” for effective penetration by UV radiation to convert the remaining precursor to ClO₂. The overall reaction is increased significantly by the pulsed irradiation and by repeating this process until a desired yield is achieved. Polarized UV is also suitable for such pulsed irradiation.

The time interval between the irradiation may vary depending on the strength of UV lamps and the duration of the irradiation, the dimensions of the container and the percent yield desired. For example, the pause period may extend from a few seconds to a few minutes. Alternatively, the pause period may be a fraction of the time required for the irradiation. For example, the pause period may vary from ⅕^{th} to about 1/20^{th} or 1/30^{th} of the time required for the irradiation phase. The frequency of the pulses may also vary. The pulsing mode need not be carried out from beginning to end and may be performed towards the later stages of the production.

One or more UV lamps can be positioned such that there exists a time interval between irradiations. The one or more UV lamps can be turned off and on such that there exists a specific period during which there is no irradiation. This cycle of irradiation followed by a pause, enhances the yield of chlorine dioxide. This cyclical irradiation pattern is established by configuring one or more lamps serially or in parallel configuration, such that an incoming flow of precursor is exposed to the one or more lamps in a serial fashion with time intervals or by turning on and off the UV lamps in a periodic mode.

The examples below are for illustrative purposes only and should not be construed as limiting the scope of this disclosure.

### Example I

### Photooxygenation of Chlorine

This experiment is carried out with a reactor or apparatus shown in FIG. 1. The space 5 of the reactor vessel 1 is flushed with oxygen, introduced through inlet 2 to replace the air atmosphere in the reactor. Gaseous chlorine and gaseous oxygen are thereafter introduced into the chamber space through inlet 2 and the quartz lamp is switched on to expose the chlorine-oxygen mixture to polarized ultraviolet radiation. The radiation emitted by the lamp has a constant intensity of 40,000 microwatts/square centimeter at 254 nanometers at 1 inch. The reference to “1 inch” indicates the distance from the center of illumination where the rated intensity is measured. The gas mixture is subjected to the radiation for five minutes. The reaction mixture within the chamber space is then expelled by flowing oxygen gas through the chamber and the expelled gas mixture is collected through the outlet 3 and analyzed for content. The analysis is verified by spectrophotometry and correlated with amphoteric titration if necessary. The presence of chlorine dioxide is thus established by observing the distinct absorbance peak of chloride dioxide. The results are confirmed by titration if needed. The procedure is repeated several times with different ratios of chlorine gas to oxygen gas to determine the most favorable ratio of reactants and also to establish the range of ratios that provides chlorine dioxide free of unreacted chlorine. Similarly, the intensity of polarized UV light can also be varied depending on the concentration of reactants and the yield. Optionally, the intensity and the wavelength of the polarized UV light can be varied over time, as the concentration of the reactants become limiting in a closed batch-type reaction chamber. Exposure times to polarized ultraviolet light can also be varied from a few minutes to a few hours.

Each of the experiments is repeated several times to verify the reproducibility and correctness of the results. Additional tests can be performed to determine a suitable exposure time/radiation intensity. For example, a 120 second-20,000 mWatts/sq. cm is a suitable exposure time/radiation intensity combination.

Temperature and pressure on the reaction can also be adjusted accordingly. For example, partial pressures of chlorine gas and oxygen can vary from about 0.1 atmosphere to about 10 atmospheres. Cl₂/O₂ ratio can also be varied. For example, O₂/Cl₂ ratio can be 1:1 to about 20:1.

In an embodiment, a constant wavelength of polarized UV of 254 nanometer is maintained during the experiments without ozone producing interfering wavelengths. If desired, several lamps may be used as a polarized UV radiation source. In one series of experiments, two lamps are used, each being rated at 20,000 microwatts/square centimeter at 1 inch. However, it is possible to use lamps rated at 4,000 microwatts/square centimeters or less, in which event, up to 10 or even more lamps may be used.

A novel method for the production of ClO₂ through the use of polarized radiation. In one embodiment of the invention, the polarized radiation is ultraviolet (UV). Without being bound by theory, it is suggested and appreciated that the mechanism of the reaction is:

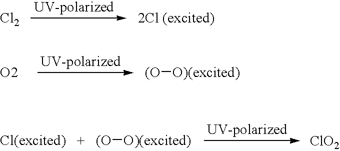

Again without being bound by theory, it is suggested and appreciated that O₂, upon exposure to polarized UV radiation, goes through an angular transformation during its transition to O₃. The UV radiation splits the O₂ molecule into two singlet oxygen atoms (O), which then strike other O₂ molecules to form ozone. While forming O₃, a bent molecule with an O—O—O bond angle of approximately 117°, the molecule, most likely in its transition state, passes through roughly the same angularity as the ClO₂, giving this temporary structure a stronger affinity to form ClO₂ (in the presence of Cl) then to continue on to O₃. The O—Cl—O bond angle in ClO₂ is 118°, which is believed to be in close proximity to the shape of the O₃ complex.

By polarizing the UV radiation, the reverse reactions are prevented from occurring. Thus, the reaction of chlorine atom with excited oxygen atoms becomes streamlined (i.e., the reaction occurs in one direction). Again, without being bound by theory, it is believed that when the polarized UV energy strikes an O₂ molecule, two individual O atoms are formed. When O combines with another O₂ molecule, this reaction happens in one direction, so that the transformation of O₂ to O₃ is angular (for example, restricting the reaction/bond formation to only two dimensions) and thus it also is polarized. If the UV radiation was not polarized, the reaction would happen in all three directions; the reaction would then incorporate a third dimension. This disfavored third dimension permits, for example, the reverse reaction because as an O₃ molecule is forming (i.e., it is in a transition state, [O₃]^{TS}) if UV radiation strikes it from any another angle, the reaction to O₃ becomes disfavored and the reverse reaction ([O₃]^{TS}→O₂+O) becomes favored, thereby limiting ClO₂ formation. Thus, the polarization reduces the possibility of this reverse reaction occurring and thereby optimizing ClO₂ yield. No free chlorine is formed in this reaction.

### Example II

### Photooxygenation of Chlorine in Water

In this experimental series, the gaseous chlorine is replaced by chlorine water, which is produced by dissolving gaseous chlorine in distilled water to a concentration of 2% w/v. The solution is introduced into the reaction spaces and is subjected to polarized ultraviolet radiation of an intensity of 20,000 microwatts/centimeters while gaseous oxygen is bubbled through the chlorine water. The resulting solution is then analyzed for chlorine dioxide content at different exposure times. Chlorine dioxide and chlorine are measured by their absorbance peaks and compared to standard concentrations.

The above experiment is repeated with the chlorine gas dissolved in a saline solution (physiological salt solution) with no apparent change in yield. The polarized UV intensity is increased to 40,000 microwatts/centimeter at 1 inch and 254 nm. This results in a stable yield at a decreased exposure time. No chlorine is detected. An increase in the concentration of the reactants does not appreciably alter the kinetics of the reaction.

### Example III

### Production of Chlorine Dioxide from Hypochlorite Solution

A 3% aqueous solution of sodium hypochlorite is acidified and diluted with water to form a 1.5% solution. The solution is then exposed to polarized UV radiation in the space 5 at 20,000 microwatts/square centimeter at 1 inch with a wavelength of 254 nm. The exposure time is 1 minute. A solution of chlorine dioxide is obtained. The procedure is repeated several times to establish its reproducibility. No free chlorine is detected. If desired, small amounts of extraneous oxygen may be added. Corresponding results may be obtained with other alkali metal or alkaline earth metal hypochlorites.

### Example III A

### UV-Based Production of Chlorine Dioxide from Chlorous Acid and Chloric Acid

A method of producing chlorine dioxide includes the steps of introducing a solution of chlorous acid or chloric acid into a reaction chamber and subjecting the chlorous acid or chloric acid to ultraviolet radiation. The chlorous acid or chloric acid concentration is from about 0.1% w/v to about 10% w/v. The chlorine dioxide generated is less than about 10% w/v, and the production of chlorine dioxide is performed in situ.

The ultraviolet radiation is provided by a ultraviolet generating lamp coated with an anticorrosive material. The anticorrosive material is Teflon or any other suitable material. The pH is maintained in a range of about pH 3.5 to about pH 5.0. The chlorine dioxide produced is removed from the reaction chamber and conveyed to a place of use or directly used along with a solution from the reaction chamber. An H+ ion exchange can also be used as a reaction chamber for ClO₂ generation using chlorous or chloric acids.

One or more UV lamps can be positioned such that there exists a time interval between irradiations. The one or more UV lamps can be turned off and on such that there exists a specific period during which there is no irradiation. This cycle of irradiation followed by a pause, enhances the yield of chlorine dioxide. This cyclical irradiation pattern is established by configuring one or more lamps serially or in parallel configuration, such that an incoming flow of precursor is exposed to the one or more lamps in a serial fashion with time intervals or by turning on and off the UV lamps in a periodic mode.

Ability to use dilute HClO₂ acid mixture with water is an additional advantage of this system for chlorine dioxide generation. Furthermore, undesirable coating on the lamp does not occur from the sodium ion of the chlorite so that the reaction chamber and the overall reaction process requires less maintenance reduce operating costs.

Speed of the reaction is increased as the pH decreases. HClO₂ or HClO₃ is more fragile to UV radiation than NaClO₂ and therefore, the dissociation of HClO₂ or HClO₃ under UV irradiation is faster as compared to NaClO₂. It was not known whether Na or other alkali metal played a catalytic role in the photolysis of NaClO₂ by UV irradiation. The present disclosure demonstrates that HClO₂ or HClO₃ by themselves, under UV irradiation, can dissociate into chlorine dioxide and other reactants, as shown in the equations described herein.

HClO₂ reacts faster than NaClO₂ to UV irradiation. HClO₃ also reacts faster to radiation, and NaClO₃ reacts slowly or not at all and may only from chloride (polar direction) upon irradiation. If UV radiation is too strong, NaClO₃ can emit O₂ gas instead of ClO₂, when the heat is excessive.

In an embodiment, the overall reaction of converting a precursor to ClO₂ is enhanced by irradiating the precursor (e.g., chlorite or any suitable precursor to generate chlorine dioxide) serially, wherein a specific “pause” period is maintained during which no irradiation is performed. This series of irradiation followed by a period of no irradiation (e.g., ⅕^{th} to 1/20^{th} the time for irradiation) increases the yield of chlorine dioxide. The serial irradiation or pulsing is accomplished by (i) turning on and off the one or more UV lamps with a specific time interval or by (ii) configuring a plurality of UV lamps positioned such that the incoming precursor for chlorine dioxide generation is exposed serially to the UV lamps, wherein there is a temporal and/or spatial interval between irradiations.

Without being bound by the underlying theory behind the periodic irradiation or pulsed irradiation, it is believed that each exposure to UV excites the precursor molecules (e.g., chlorite or any suitable precursor for UV-based ClO₂ generation), a photon is discharged and ClO₂ is formed by the reactions disclosed herein. The presence of ClO₂ (yellowish) acts as interference for further UV penetration during an extended synthesis phase. Thus, the rate of ClO₂ generation is diminished as the UV exposure continues or toward the later stages in the production. The reaction is not a linear progression, but proceeds more of a parabolic nature showing diminishing returns. A hypothetical model of the progression of ClO₂ yield with UV pulsing (solid line) and without UV pulsing (dotted line) is shown below.

By giving the irradiated solution a pause from irradiation, allows the reaction to settle (e.g., the overall entropy goes down and the yellow color decreases). This pause allows the solution to once again become “ready” for effective penetration by UV radiation to convert the remaining precursor to ClO₂. The overall reaction is increased significantly by the pulsed irradiation and by repeating this process until a desired yield is achieved. Polarized UV is also suitable for such pulsed irradiation.

The time interval between the irradiation may vary depending on the strength of UV lamps and the duration of the irradiation, the dimensions of the container and the percent yield desired. For example, the pause period may extend from a few seconds to a few minutes. Alternatively, the pause period may be a fraction of the time required for the irradiation. For example, the pause period may vary from ⅕^{th} to about 1/20^{th} or 1/30^{th} of the time required for the irradiation phase. The frequency of the pulses may also vary. The pulsing mode need not be carried out from beginning to end and may be performed towards the later stages of the production.

In an embodiment, chlorine dioxide is produced from chlorous acid shown by a general equation shown below:

5HClO₂→4ClO₂(gas)+Cl⁻+5H⁺ (3)

In an embodiment, chlorine dioxide is produced from chloric acid shown by a general equation shown below:

HClO₃→ClO₂(gas)+OH⁻ (4)

The chloric acid is produced by the addition of a strong acid to NaClO₃ at point of site. The acid plus chlorite reaction is generally stoichiometric.

With the use of any acid including the mineral acids and organic acids and H+ ion exchange mechanism, hypochlorous acid as well as hypochlorous acid made from Cl₂ (gas) and H₂O can also be used.

Dissociation of HClO₂ from chlorite or chlorate is linear with output to H+ ion concentration. Dissociation of chloric acid from chlorate is directly proportional to the concentration of H+ contributed by acids

3H⁺+ClO₃⁻→HClO₂+H₂O+[Acid/Salt]

2HClO₃→(UV)→ClO₂+HCl+H₂O

The stability of both chlorous acid and chloric acid are questionable for long periods of time. However, their production on site from their respective chlorite or chlorate mixture there of offers stability and long storage capabilities.

Removal of ClO₂ gas from solution as a pure gas can be accomplished by a stream of air (positive or negative), and the removed chlorine dioxide gas can be readily used to or temporarily stored in cold water for later use. Removal of ClO₂ gas can also be performed by applying continuous or periodic vacuum in the reaction chamber.

Mercury vapor lamp (5000 v; 40 milliamp current) can also be used and maintained at 32° C. or any suitable ambient temperature and pressure. All wetted parts are protected by inert materials to ClO₂ and UV radiation, and the reaction surface is reactive to volume of flow or contaminant.

Exposure to irradiation time is directly proportional to concentration of [ClO₂]+[H+] or [ClO₃]+[H+] and wattage of radiation.

### Experiment IV

### Stability

Example I may be repeated to obtain different concentrations of chlorine dioxide in the presence of oxygen. Expected results are obtained until the chlorine dioxide concentration approaches about 8%. An instability of the kinetics after a concentration of 8% may be reached due to an inherent instability due to bond acceptance of electrons under continuous polarized UV radiation or donation of electrons to another acceptor to produce a high oxygenation of chlorine with a reduction of the O—O bond distance, thus making the reaction reversible and unstable at high concentrations. Accordingly, the parameters should be chosen so that the chlorine dioxide concentration does not exceed about 10%.

As will be appreciated from the above, excited oxygen and excited chlorine combine to form chlorine dioxide under polarized UV. Excited Cl₂ may remove electrons without breaking the (O—O) bond to form chlorine dioxide. It is believed that the reaction corresponds to oxygenation rather than oxidation, with the distance of the dioxygen bond being increased during the radiation with polarized UV.

Excited chlorine is produced by polarized ultraviolet radiation. Excited (O—O) is produced by polarized UV radiation. The (O—O) bond distance may be increased by polarized UV radiation from 1.30 A to 1.62 A depending on the intensity of the radiation.

Chlorine (excited) and oxygen combines best in an oxygen intensive concentration. The presence of nitrogen lowers the yield, but does not stop the reaction. The chlorine dioxide recovery or yield is a direct function of the exposure time. The exposure time, in turn, is dependent on the intensity of the polarized UV source.

Temperature and pressure do not directly affect the kinetics of the reaction. However, they may impede or increase polarized UV penetration. Extreme temperatures and reduced pressure may lead to the disassociation or transference of electrons to another acceptor. This may lead to the formation of perchlorates. Changes in the kinetics due to higher concentrations of chlorine and oxygen can be observed, and it may be assumed that extreme temperatures and pressure changes will lead to internal energy changes, which, in turn, in a limited volume, increase the instability of the reaction.

No chlorine dioxide formation is observed in the absence of polarized ultraviolet radiation.

### Example V

### Atomization and Increase in Efficiency of ClO₂ Production

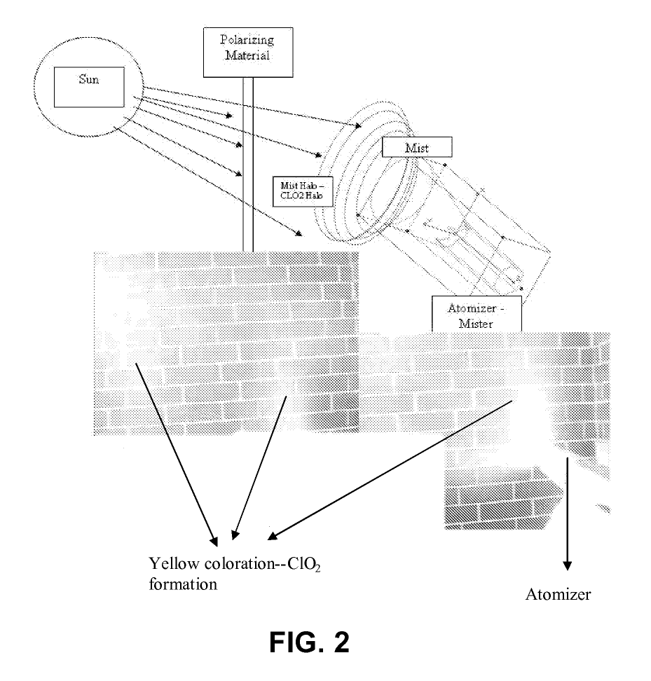

This example demonstrates that atomizing (dispersion into small size droplets) a chlorite solution or any suitable reaction mixtures prior to or contemporaneously irradiating by UV, results in an increased production of chlorine dioxide. Atomizing or spraying or vaporizing can be performed by any suitable equipment such as an atomizer, a container equipped with a spray head and the like (FIG. 2).

For example, a spray bottle equipped with a fine spray head and filled with a chlorite can be used to generate ClO₂ by simply spraying the chlorite solution under the sun, wherein the UV radiation present in the sunlight may be sufficient to catalyze the formation of some of the chlorine dioxide from chlorite.

The atomized spray or mist is converted to chlorine dioxide as the reactive droplets are exposed to sunlight or any suitable UV irradiation (FIG. 2). In an aspect, the spray bottle containing the chlorite solution is useful for disinfecting crops, or any other entity, in the presence of sunlight by spraying over the crops or other articles that need to be disinfected. The spray equipment can be portable or they can also me be made in a larger size.

In an embodiment, when a mist of chlorite solution is sprayed under sunlight, ClO₂ gas (yellowish in color) is generated. Without being bound by a particular theory for the mechanism of action, it is believed that a substantial increase in surface area due to the formation of the mist or an atomized spray, the UV is able to better penetrate and effectuate an increase in efficiency of ClO₂ generation.

In another embodiment, a stable solution of chlorite (e.g., sodium chlorite) is contained in a spraying or atomizing container and sprayed along with an irradiation source (e.g., UV lamp) that is functionally integrated to the spray container.

In another embodiment, the ClO₂ generated after the spraying and irradiation, is trapped into the same or another container such that the ClO₂ gas is dissolved in a liquid, e.g., water. The ClO₂ dissolved liquid is also used as a disinfectant.

As disclosed herein, increasing the concentration of the chlorite solution or by minimizing the light scattering, that is, by using a polarized UV irradiation, the efficiency of ClO₂ production can be further increased in combination with the formation of mist or atomized spray.

In another embodiment, the efficiency of ClO₂ formation is increased by minimizing light scattering due to Rayleigh effect and Mie theory (also called Lorenz-Mie theory) of scattering and John Tyndall Scattering (light passing through fluid is scattered by suspended particles) effect.

### Example VI

### Increase in Efficiency of ClO₂ Production by Use of Successive Chambers or by a Cascade of Irradiation Sources (e.g. UV Lamps)

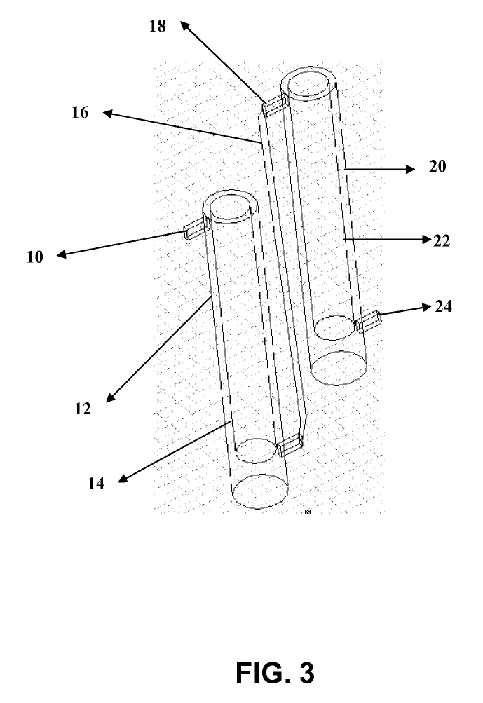

In an aspect, a device for the production of chlorine dioxide includes a plurality of chambers or partitions, wherein the chambers are positioned consecutively or successively (FIG. 3). In an embodiment illustrated in FIG. 3, a first chamber 12 has an inlet port 10 for reactants to enter. A source for UV radiation such as a UV lamp 14 is positioned within the chamber 12. An interconnecting tube 16 joins the first chamber 12 with the second chamber 20. The second chamber 20 also has an inlet port 18, a UV lamp 22 and an exit port 24.

Each chamber also includes a source for irradiation or alternatively, a different irradiation source is introduced in the chambers periodically. Use of consecutive or successive chambers reduces the scattering effect due to deposits on the irradiation source (e.g., UV lamp). The polarizing effect of the UV light, in certain cases, draws the chlorate ion towards the source, thereby depositing on the lamp. This deposition of the material tends to increase the light scattering and thereby decreasing the efficiency of the polarized UV light to catalyze the formation of ClO₂. Therefore, transferring the solution from the first lamp and first chamber to the second lamp and the chamber results in a reduced scattering because some of the interfering chlorate ions are left behind in the first chamber.

In another aspect, the scattering effect is also decreased by the use of a magnetic polarization and/or electrical polarization in the first and second chambers.

In an aspect, two or more lamps are used in a cascade. A schematic illustration of such an embodiment is shown in FIG. 3. Two UV lamps are connected successively, wherein the UV lamps are turned on and off consecutively or the solution containing the reactive mixture for generating ClO₂ is brought within the proximity of the lamps for the desired reaction.

Without being bound by a particular theory or function, using chambers in succession reduces the scattering effect of about 350 nm by ClO₂ (yellowish or yellowish brown) scattering effect (Rayleigh and Mie) of the light as well as the chlorate effect on scattering. Some amount of chlorate is present with chlorite (dry or liquid). The chlorate group out in successive chambers. Chlorate also migrates towards the source (lamp) and collects on the lamp and it has to be rinsed off with acid for complete removal. Each successive chamber configuration results in a lower accumulation of chlorate. The presence of chlorate on the lamp and in the solution scatters and absorbs useful UV light. Successive chambers reduce the ability of secondary chemicals of absorption or scattering effect.

Movement of the reactants from one lamp to another creates a condition of intermittent UV exposure and this overcomes the problem of ClO₂ degradation as observed with commonly available ClO₂ products with labels warning not to expose to light.

### Example VII

### Increase in Efficiency of ClO₂ Production by Use of a Coiled Configuration of a ClO₂ Generation Device

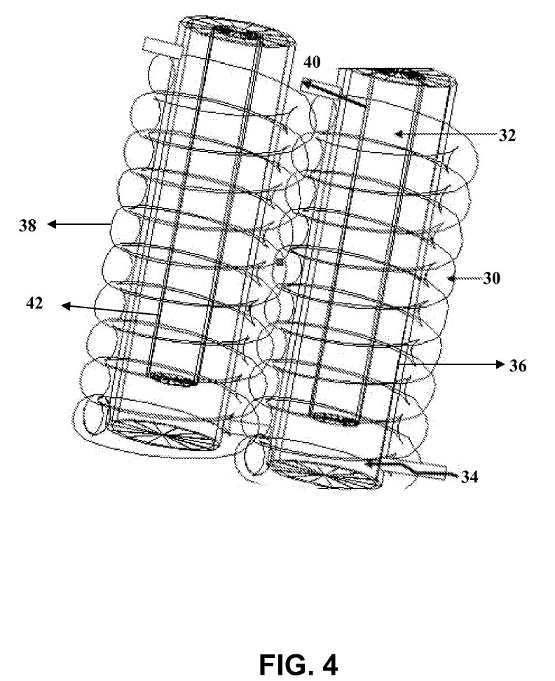

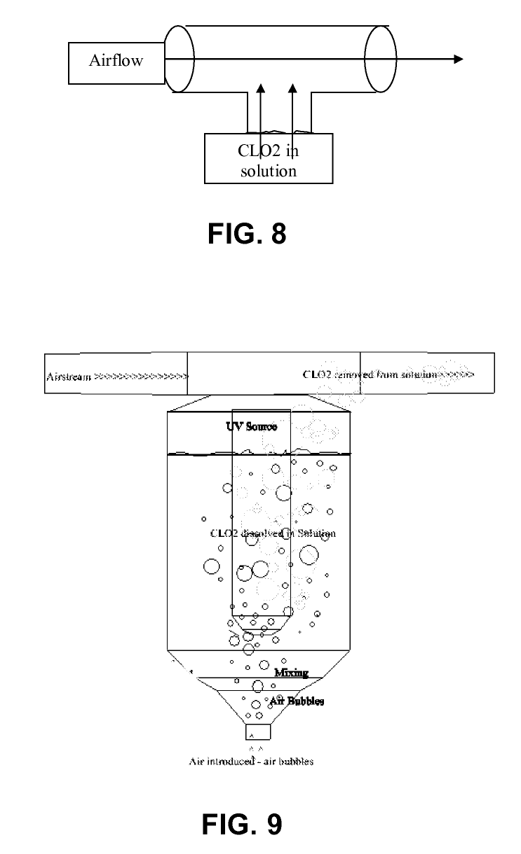

Illustrated embodiments shown in FIGS. 4-8 relate to coiled configuration of ClO₂ generation devices. For example, a thin Teflon™ (poly tetrafluro ethylene) coil that contains a solution of a chlorite (e.g., sodium chlorite) acts as a device with multiple chambers for continuous flow. The coiled configuration also reduces the scattering effect due to particulates or deposits that form on the lamp surface. The coiled setup also increased the effectiveness and efficiency of ClO₂ production from chlorites as well as molecular oxygen and chlorine gas mixture.

In the embodiment shown in FIG. 4, a chamber 30 with a coil configuration is shown in a cascade configuration with another chamber 38. The chamber 30 has a UV source 32 and a cooling member 36. The cooling member encapsulates the light source 32. This cooling member reduces the heat generated from a light source (e.g., UV lamp) and thereby maintains the UV lamps at a higher operating condition. The cooling member is adapted to receive a variety of fluids including air. Some of the factors considered during the design and manufacturing of the tubing and the cooling fluid include (1) capable of transmitting UV light; (2) should not significantly absorb UV energy; (3) should not significantly corrode the reaction chambers; (4) desirable thermal properties; (5) minimizes scattering of UV; (6) ability to withstand reactants; and (7) relatively inexpensive. Suitable material for fabricating a cooling member includes, e,g., UV transmitting glass or plastic or polytetrafluroethylene (Teflon™). The cooling member can be made of Teflon and the cooling fluid can be air or water. The cooling member 36 has an air inlet port 34 and an air outlet port 40. The second coil chamber 38 has a separate UV source 42.

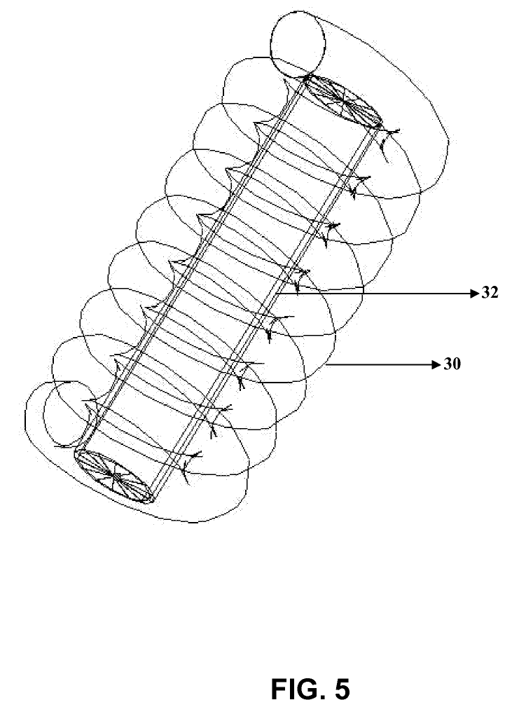

In the embodiment shown in FIG. 5, a cooling member 36 is not present. Instead, the circulating reactive material inside the chamber 30 itself may cool the lamp 32.

The coiled arrangement of the device also increases the surface area available for exposure to UV and also minimizes the loss in efficiency due to scattering.

All the configurations of ClO₂ generation devices disclosed herein can be used in combination with the polarizing filters disclosed herein. An embodiment of a polarizing filter, for example, is shown in FIG. 9. In addition, electromagnetic effects also can be implemented to increase the overall efficiency.

The reactive mixtures suitable for use to generate ClO₂ include, for example, chlorine gas and oxygen gas; sodium chlorite; potassium chlorite; other suitable chlorites. Chlorous acid (HClO₂) and chloric acid (HClO₃) are also suitable to produce ClO₂ gas by UV irradiation as disclosed herein. For example,

Chlorine dioxide from chlorous or chloric acid is generated following general equations shown below:

xHClO₂→yClO₂(g)+xH⁺ (1)

x and y can be any integer.

xHClO₃→yClO₂(g)+xOH⁻ (2)

x and y can be any integer.

In another embodiment, an oxygen concentrator can be used to provide a continuous supply of oxygen to form a reactive mixture with chlorine upon exposure to UV.

The efficiency of the coiled configuration device can be further increased by increasing the intensity of the bulbs (e.g., varying the voltage and power).

Without being bound by a particular theory or mechanism, it is believed that some of the byproducts of the reaction, e.g., chlorate and other suspended particles may settle in the lower portion of the coil (polarized by light source) and due to the effect of gravity on the heavier particles. This settling of potential light scattering components in the lower portions of coiled configuration may result in reduced scattering and therefore increases the efficiency of chlorine dioxide production. In addition, as described herein, the coil configuration also increases the amount of reactants being exposed to UV by maximizing the surface area.

In another aspect, the coil configuration enables providing reactants in-line and using a flushing a liquid e.g., water to flush the lines to eliminate built-up particles (e.g., chlorate and other particles that were settled and/or deposited and left behind) and to further reduce scattering. Gravity helps grouping of the byproducts, because the coils go from top to bottom horizontally and also aided the flushing of particles. In the coil, as the heavier chlorate ions are drawn to the lamp, the lighter chlorite ions move continuously down the coil, past the congregated chlorate ions. This allows a continuous flow between chambers, and there is no need to stop the flow to clean up the interfering agents.

The efficiency of the reaction can be increased by providing a thin layer of reactants to the UV source. This can be performed, for example, by providing coils that are narrow and thereby maximizing the amount of time and area of reactants for exposure to radiation.

The coil also offers another advantage by keeping the flow of reactants and products moving and does not allow for air gaps at the top of the chamber. Air gaps can saturate chlorine dioxide being released from liquid and have potential for explosion. The fluid keeps moving, and the ClO₂ stays in the fluid because there is no period of time where the fluid is stationary or stored to cause dangerous explosions. Storage of stopped precursor has the potential to release ClO₂ into the container.

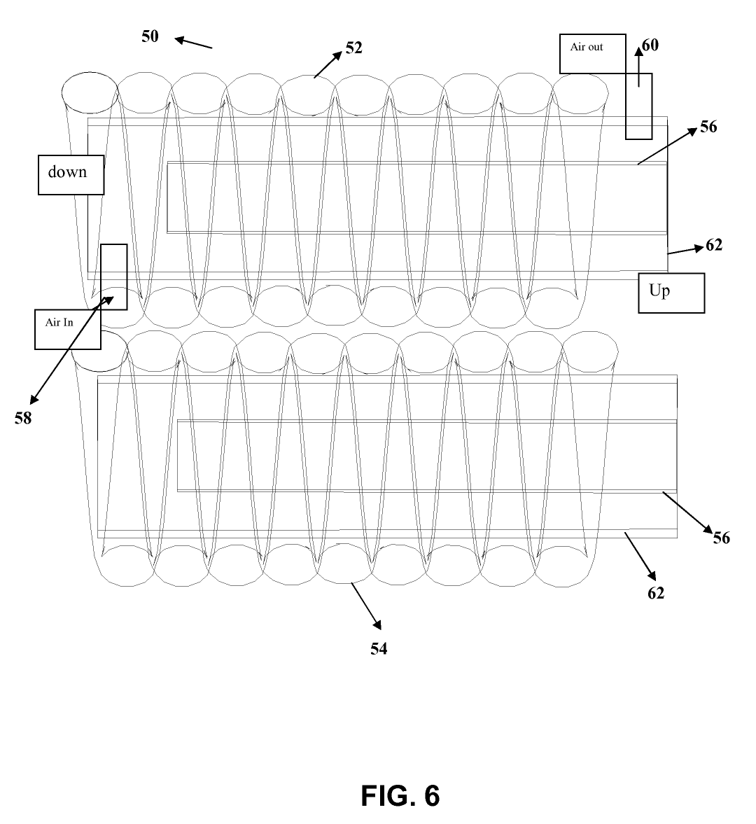

In the illustrated embodiment shown in FIG. 6, the horizontal arrangement 50 of the coils 52 and 54 provide reaction conditions where the heavier by products settle down and minimize scattering and dispersion of UV radiation from the UV lamps 56. There are air inlet ports 58 and outlet ports 60 to cool the lamps 56. The cooling member 62 surrounds the lamps 56.

### Example VIII

### Minimizing Scattering Due to Suspended Particles

As disclosed herein, there are several ways to minimize scattering due to suspended particles. For example, movement of the reactant fluid (e.g., containing chlorite) during and after exposure to the UV radiation randomly changes the position of the suspended particles in relation to the UV source and minimizes scattering effect and increases polarization of the radiation. Moving the fluid and stirring the fluid (e.g., using a Teflon™ coated magnetic stir rod) reduce the scattering effect.

Polarizing the light source through polarized filters also reduces the scattering effect. Applying a magnetic field also polarizes the fluid, draws the negatively charged chlorite from chlorine dioxide.

Temperature and density of material also affects the intensity of the Rayleigh scattering and fluctuation temperature affects the yield. ClO₂ is more soluble in cold water. Changing the temperature and pressure affected the yield. Reducing the Rayleigh scattering effect, the John Tyndall effect and Mie scattering substantially increase reaction efficiency and also eliminates the ‘reversing’ effect.

During the process of creating the ClO₂ molecule, from irradiation of chlorite or chlorine & oxygen gas by UV at the short wavelengths, the nascent molecule of ClO₂ is excited and the intensity of light (photons) being discharged sufficiently scatter incoming UV and degrade the intensity of the exposure. After some time, if the UV radiation is suspended, the intensity of the nascent (excited state) ClO₂ decreases, the Mie scattering potential is reduced.

### Example IX

### Removal or Discharge of Chlorate During the Generation of ClO₂

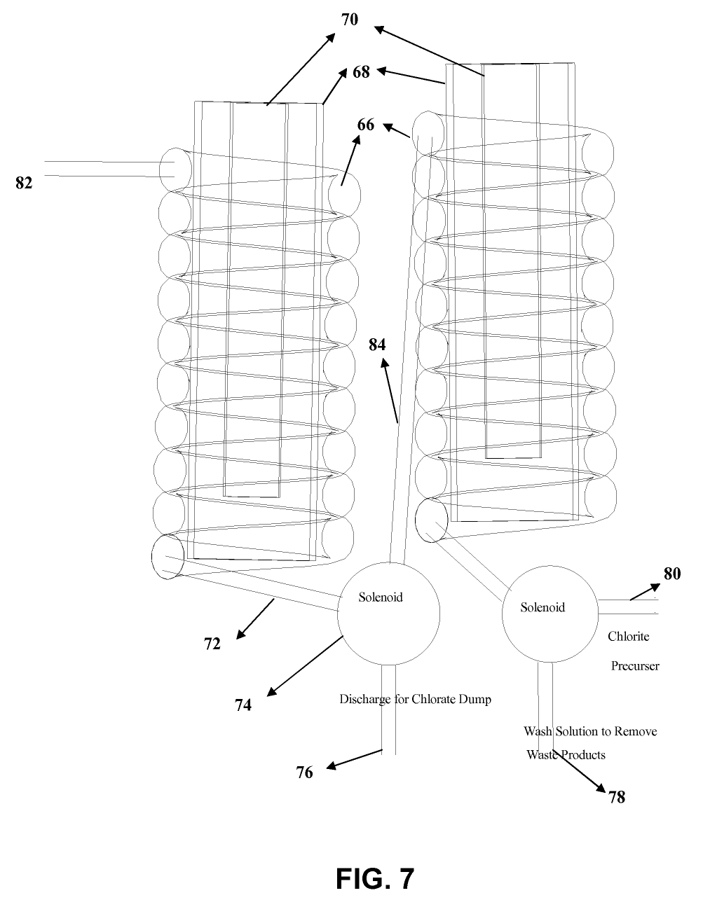

An illustrative embodiment in FIG. 7 shows a provision to remove chlorate during the generation of chlorine dioxide. Drinking water containing chlorate has to be treated with sulfur compounds or activated carbon or iron salts like ferrous chloride to remove chlorate. Chlorate is present in the solution as sodium chlorate, and it is disclosed herein that it can be polarized and grouped during the ClO₂ reaction. This grouping produces a white film on the lamp that is left over after the reactions.

In the illustrated embodiment shown in FIG. 7, two successive coil chambers 66 are interconnected by a tube 84. UV lamps 70 are surrounded by cooling members 68. Reactant inlet port 82 introduces the reactant for chlorine dioxide production. During a continuous production of chlorine dioxide, the reactants, products and by products are transported by a tube 72 for chlorate removal using a solenoid control 74 and the chlorate is removed by a chlorate dump 76. Wash solution to remove waste products is provided at a port 78 and the chlorite precursor is removed for recirculation at port 80.

If chlorite is reacted and removed, the process of cleaning drinking water is enhanced because the pollution associated with the reaction is lowered.

Again, multiple compartments, coils, polarization (both of light and of the material by the light and or magnetism) decrease scattering. Mechanical improvement—air or water cooling of light source, air has less scattering and better improvement. The grouping of chlorate (as seen by the thin film remaining on the lamp) can be discharged and dumped separately than the product. This allows for better disinfection-oxygenation of water—an improvement for drinking water usage. As shown in FIG. 7, each successive reaction chamber removes more chlorate although a greater concentration of chlorate can be dumped after the first reaction chamber.

The sodium chlorite solution, e.g., 25% is generally not pure. Sodium chlorite itself can be made up to 80% by U.S. law, because of its dangerous explosiveness. The chlorate particles, part of the chlorite solution, are suspended in the solution and inhibit the ability of the UV light to act at 100% efficiency in the reaction. These suspended particles absorb light and scatter light. The concentration of chlorite can be increased through polarization and successive chambers as disclosed herein.

### Example X

### Removal or Discharge of Chlorate During the Generation of ClO₂

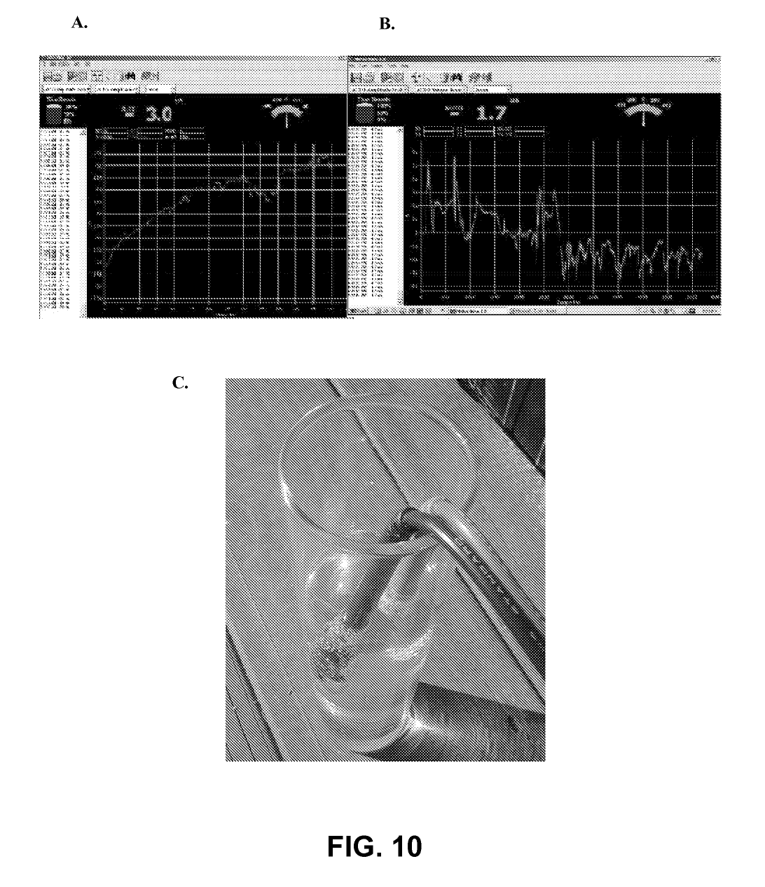

Removal of ClO₂ can be performed with a stream of air or inert gas or vacuum or agitation or diffusion. Vacuum can be applied through a pump. A schematic illustration of Venturi effect is shown in FIG. 10, wherein passing a stream of air in a chamber draws ClO₂ out of the storage for removal of ClO₂.

### Example XI

### Influence of Electromagnetic Field (EMF) or Electromotive Force (EMF) on the Generation of ClO₂

Without being bound by a particular theory or mechanism, it is believed that the formation of ClO₂ is enhanced by the presence of an electromagnetic field or an electromotive force. Applying EMF favors the forward reaction resulting in the formation of ClO₂ and minimizes the reverse reaction, i.e., decomposition of ClO₂ in to its constituents, as illustrated below. Electromotive force (EMF) is the amount of energy gained per unit charge that passes inside a device in the opposite direction to the electric field existing across the device's external poles. EMF is measured in volts.

In one aspect, the reactions are shown in an embodiment:

NaClO₂→UV→Na⁺+ClO₂ (chlorine dioxide); this reaction has a higher chance to reverse in the absence of an applied EMF (FIG. 4A)

NaClO₂→UV (EMF)→Na⁺+ClO₂ (chlorine dioxide); this reaction does not reverse when an EMF is applied (FIG. 4B).

Any suitable source of EMF is useful, including but not limited to battery, magnet, current field, and other power sources or irradiation sources.

In one embodiment, sunlight and chlorite solution were used to generate ClO₂ in the presence and absence of additional EMF. In FIG. 10A, the reaction does not reverse, in part, due to the EMF generated from a battery (not shown) and in FIG. 10B, there is some reversion because no additional EMF was added.

In another embodiment, it is believed that the EMF created in one chamber may help ClO₂ in other adjacent chambers from reversing. The strength of EMF needed is small.

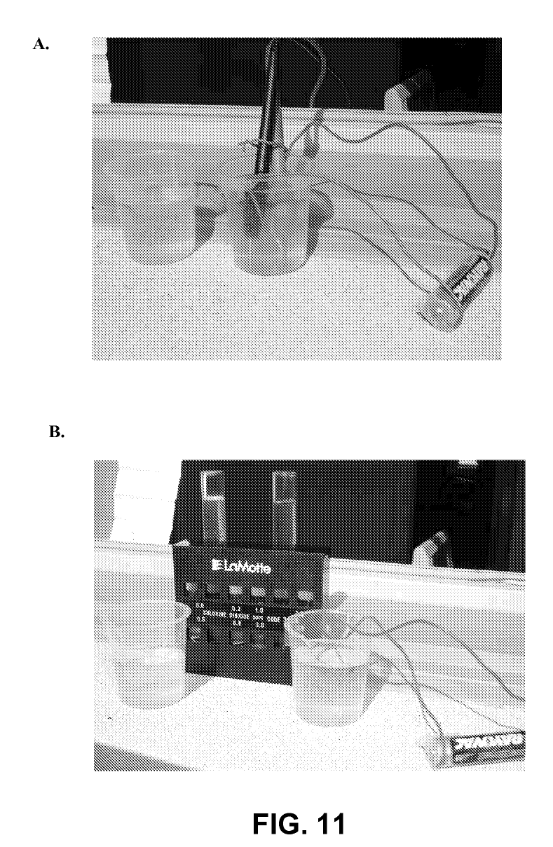

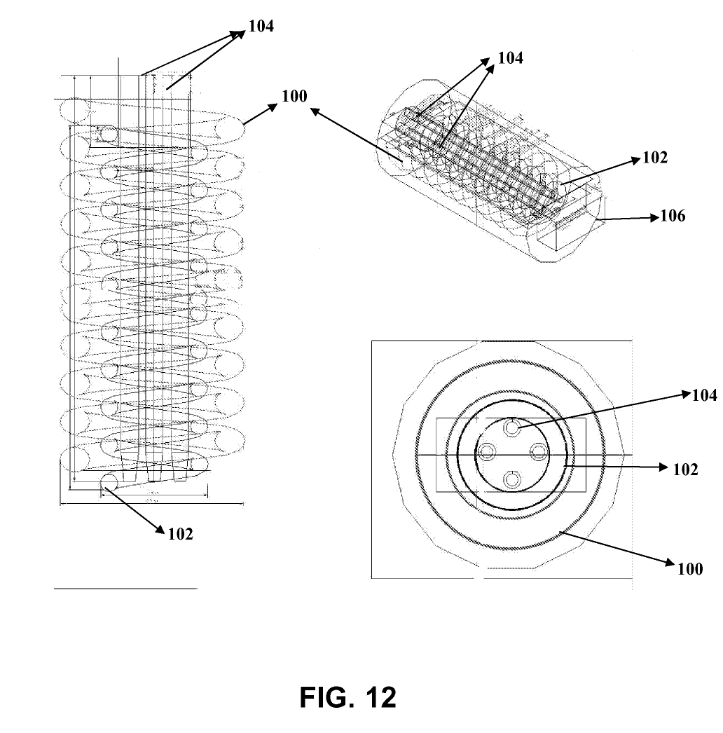

FIG. 11 shows an experimental set-up showing the influence of EMF on ClO₂ generation. Two one-ounce Teflon beakers containing 25% chlorite solution are used to generate ClO₂. One of the beakers has an electric current running through the solution to create an EMF. In an embodiment, sunlight was used as the irradiation source, although any suitable UV source is capable of generating ClO₂. The beaker that has the additional EMF produced more ClO₂ and the generated ClO₂ was more stable (yellow) due to the EMF. The p.p.m. indicator in FIG. 11B shows different shades of pink and also demonstrates that application of EMF reduces the rate of reversal to chlorite. The absorbance of ClO₂ was measured at 343 nm.

Two histograms measuring millivolt (mv) in the solutions of chlorite that were used for ClO₂ generation in FIG. 11 were compared. The addition of a small sufficient current, reduces the reversal of ClO₂ to chlorite in the solutions, when being exposed to a UV source, such as sunlight. Applying EMF is believed to reduce the overall chaos of the reaction, and when the EMF is not applied, the reaction is believed to reverse at alternating rates and the overall effect of exposure. With the addition of EMF that is sufficient enough to overcome the reversal, the reaction reaches equilibrium and ClO₂ does not reverse as much as without EMF.

In an aspect, without being bound by a particular theory or mechanism, it is believed that the addition of EMF appears to allow the reaction to happen at a higher concentration and at a higher efficiency. When the applied EMF is held constant over a period of time, this stability allows the reaction to go to completion.

In an embodiment, the UV lamps themselves may also provide sufficient EMF to minimize the reversal rate. Because UV lamps are powered by electric current, there may be basal EMF that aid in reducing the reversal rate. Therefore, additional EMF can be introduced in the reaction, simply by providing a more powerful UV irradiation source or alternatively, providing an EMF source coupled to the lamp itself.

In another embodiment, EMF can be introduced by a powered handheld UV lamp and can be used in conjunction with an atomizer that generates ClO₂. Sunlight also helps to reduce the reversal rate.

EMF can be applied to a ClO₂ generation device of any configuration—single chamber, multiple chambers, coils, tubular, and any suitable device. EMF application can also be combined with any other ClO₂ generation-enhancement technique, e.g., polarization and stirring.

The wires used in an experiment used to induce a current in the solution showed oxidation on the positive pole, indicating the controlled flow of electrons and the controlled reaction. Oxidized wire in the solution that is oxidized only on the + side indicates the effects of current on oxidation.

It is believed that UV and EMF (whether from an induced direct current or as a result of flux from an electrical device like the lamp) maintain the reaction from reversing and favors the reaction to proceed in the forward direction.

In an embodiment, the reaction is indicated as follows, although other reactants and other modes are readily understood by a person of ordinary skill in the art.

Chlorite+UV=ClO₂;

ClO₂−EMF=Chlorite; (this is a reversible reaction in both directions).

However, Chlorite+UV+EMF=ClO₂; (this is a stable reaction proceeding to completion for producing ClO₂).

Contrary to what is generally believed, that exposure to direct light is harmful for ClO₂-based products, the disclosure herein identifies a mechanism that minimizes reversal rate by providing an EMF. It is generally believed that exposure to sunlight reverses ClO₂-based product to chlorites containing compounds.

In another embodiment, EMF can also be applied by submerging an energized bulb in the solution of chlorite, the reduction of scattering effect (by using multiple chambers) and the polarization of the solution, by polarizing the chlorate—also a function of the multiple chambers. Other improvements such as the coil, atomizer, and EMF through direct and alternating current are also suitable.

It is believed that chlorite can hold a charge from the sun or from another UV source, and when removed from the sun, it discharges. Both using a hand-held UV bulb and the sun light, the chlorite is energized by UV, then discharges the EMF to generate ClO₂.

Application of EMF is believed to be suitable for any photo-sensitive chemical for use in ClO₂ generation. For example, sodium chlorite, lithium chlorite, calcium chlorite, magnesium chlorite, potassium chlorite, and others. Any molecule that exhibits a preference to absorb UV rays and then produce EMF as they convert back are suitable for affecting the desired reaction by applying additional EMF. For example oxygen, and halogens such as Cl, Br, I, and fluorine are suitable agents.

Similar methods and approaches can also be used to increase the efficiency in a solar battery.

Application of EMF is also suitable for other reactive oxidizers such as chlorine gas, peroxide, ozone and others.

Thus, EMF application is suitable for any reaction that involves UV-based generation of ClO₂. EMF application is also suitable for any reaction that involves generation of ClO₂.

### Example XII

### ClO₂ in Oil Disinfects and Deodorizes the Oil

Without being bound by a particular theory or function, it is believed that oil traps or holds ClO₂ and that the ClO₂ functions as a disinfectant or deodorizer. Therefore, oils dosed with ClO₂ or a ClO₂ generating compound can be used in cutting oil, to clean up cutting machines, oil rig cutters, and others.

In an embodiment, oil including vegetable oil, oil derived from other sources, are suitable for dosing with ClO₂. ClO₂ can be infused to the oil by bubbling ClO₂ gas or by providing a source that generates ClO₂ (e.g., mix of chlorite and weak acid). Because larger amounts of ClO₂ can be dosed in the oil, ClO₂ dosed oil can be used as a transporting medium or for storing higher concentrations of ClO₂. Oil is thus able to capture or trap ClO₂ in a non-reactive environment. ClO₂ dosed oil is a stabilized form of ClO₂.

### Example XIII

### Simultaneous Generation of ClO₂ and Ozone to Enhance the Disinfection/Sterilization

Simultaneous generation of ClO₂ and ozone enhance the disinfection/sterilization capacity. In an embodiment, this is accomplished by having co-extensive coiled configurations that enclose an irradiation source as illustrated in FIG. 12.

Ultraviolet irradiation of chlorite or any suitable chlorine dioxide precursor generates chlorine dioxide. For example, an ultraviolet lamp having an irradiation intensity of about 50-80 watts or about 25-100 watts and having a wavelength in the range of about 254 nm plus or minus 100 nm is suitable.

Upon irradiation of the chlorite solution, the chlorite is converted to ClO₂. Other features such as a polarized light source, additional EMF, reduced scattering, coiled configuration of the reactor, multiple UV lamps, successive chambers can also be present.

As illustrated in FIG. 12, an outer, larger diameter coil 100 is used to contain material to be sterilized or disinfected and an inner, smaller diameter coil 102 is used to produce ClO₂ that can further sterilize/disinfect the desired material. All the coils used in this embodiment are non-reactive to chlorine dioxide, ozone, precursors and allow UV penetration. Suitable material includes Teflon and quartz tubings or a combination thereof. In the illustrated embodiment shown in FIG. 12, four UV lamps (104) were used. Any suitable number of lamps can be used.

The irradiation from the UV lamps 104 can penetrate the reactor surface, e.g., Teflon tubing or coil 102 and disinfect an adjacent coil 100. For example, UV light penetrates coil 102, produces chlorine dioxide from chlorite and further penetrates coil 100 and disinfect circulating dirty water. In addition, air is passed over the UV lamps 104 to cool the lamps. The UV irradiation generates ozone and this ozone can be recirculated or reintroduced into coil 100 carrying the dirty water for further disinfection/sterilization. The chlorine dioxide produced from coil 102 is also dosed into coil 100 carrying the dirty water for further disinfection/sterilization. Further, the UV light from the UV lamps 104 are powerful enough to directly sterilize the dirty water in coil 100. The additional sterilization effect by ozone can be used to reduce the demand and consumption of ClO₂. UV-permissive tubing maximizes the synergistic disinfection effects of ClO₂ and ozone and direct sterilization effect of UV can also aid in biocide effectiveness. A fan 106 may also be used to cool the lamps. An outer chamber may also be used to further enclose the coils and the lamps.

The synergistic effects of ClO₂ and ozone along with the direct sterilization by UV results in an enhanced and effective disinfection process. In addition, the effective disinfection is achieved in a single unit set-up without the hassle of transporting ClO₂ to a water treatment facility or any other distant location. Therefore, this combination ClO₂-ozone generator saves space, set-up time, and provides superior disinfection capability.

Other configurations such as pulsed radiation and/or polarized radiation can also be used in the illustrated device shown in FIG. 12. Without being bound by the underlying theory behind the periodic irradiation or pulsed irradiation, it is believed that each exposure to UV excites the precursor molecules (e.g., chlorite or any suitable precursor for UV-based ClO₂ generation), a photon is discharged and ClO₂ is formed by the reactions disclosed herein. The presence of ClO₂ (yellowish) acts as interference for further UV penetration during an extended synthesis phase. Thus, the rate of ClO₂ generation is diminished as the UV exposure continues or toward the later stages in the production. The reaction is not a linear progression, but proceeds more of a parabolic nature showing diminishing returns.

### Example XIV

### Synergistic Production of ClO₂

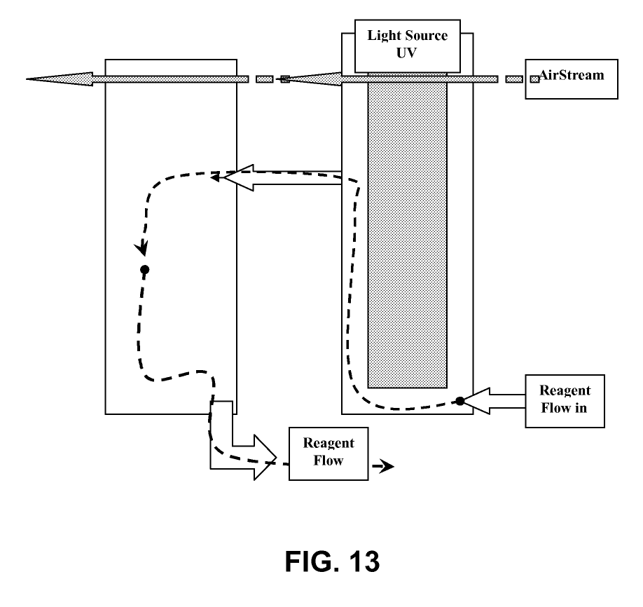

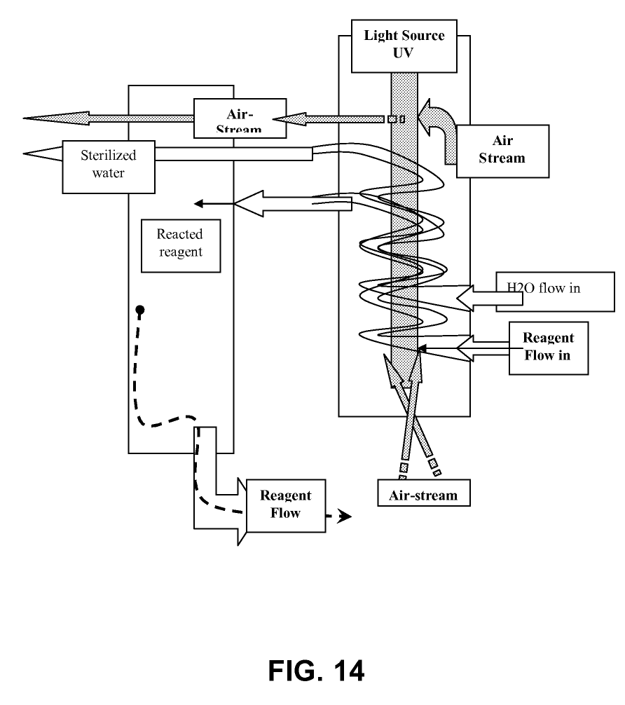

In the illustrated shown in FIGS. 13-14, UV bulbs in a submerged mode (vs. shinning) onto a solution were used. This configuration allows to manage temperature gradient and manage the output of ClO₂ dispersed versus escaped. The submerged bulbs impart EMF through applied voltage in the bulb. Applied EMF minimizes reversal rates. The air stream is used to remove ClO₂ to further accelerate the production of chlorine dioxide. The addition of a second capillary to remove ClO₂ keeps ClO₂ from reversing to NaClO₂ and also allows recirculation of reagent for purposes of keeping contaminants away from source. The submerged light source allows for managing intensity gradient and this configuration allows complete removal of ClO₂. In FIG. 14 a coil configuration is used instead of a cylindrical reaction chamber used in FIG. 13. This configuration allows the synergy of using UV to produce ClO₂ from reagent and to produce and introduce O₃ from the cooling air blown over the lamp. Incoming O₂ concentration in the air-stream allows controlling O₃ as well. In addition, the water is also exposed for sterilization.

Sonic waves (sound, vibration, ultra sound, high frequency), increase the kinetics of the chlorine dioxide reaction. Therefore, sound waves can also be used in conjunction with producing ClO₂ using UV and chlorite (or chloric or chlorous acid) in an aqueous solution.

Maintaining the temperature of the reaction mixture also increases the efficiency of ClO₂ production. However, if it is desired to keep the ClO₂ in solution longer, a cooler temperature is maintained. As the temperature increases, solubility of ClO₂ decreases. Also, as temperature increases, ClO₂ may turn to chlorate, reducing the yield. Thus, the volatility of ClO₂ increases. If the temperature is too high, the ClO₂ bubbles off and the yield decreases as ClO₂ forms chlorate around 37° C. If the temperature is too low, the reaction reverses easier. Therefore, maintaining the temp gradient by flowing water, intermittent exposure, circulating coil, submerging a bulb, using a cooler bulb aid in maximizing the yield and in decreasing reversal.

In contrast, maximizing the bubbles and release of ClO₂ can be achieved by maintaining a higher temperature at the same time balancing the yield of chlorate if the application requires more ClO₂ released into the air as apposed to remain in liquid for disinfection purposes.

The synergistic effect of using the byproducts of the UV-ClO₂ reaction for germicidal effects is also contemplated. For example, byproducts of O₃ produced by the UV radiation and the UV radiation itself can be used for further germicidal applications. Such a device would be both an odorizer and germicide. This device allows the application of ClO₂, UV and O₃.

While embodiments have been illustrated and described in the drawing and foregoing description, such illustrations and descriptions are considered to be exemplary and not restrictive in character, it being understood that only illustrative embodiments have been shown and described and that all changes and modifications that come within the spirit of the disclosure are desired to be protected. The applicant has provided description and figures which are intended as illustrations of embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features and/or steps of the disclosure and fall within the spirit and scope of the present disclosure and the appended claims.

1. A method of producing chlorine dioxide, the method comprising:
introducing one or more reactants for chlorine dioxide production into a reaction chamber to form a reaction mixture; and
subjecting the reaction mixture to one or more of the treatments comprising:
(a) exposing the reaction mixture to a polarized ultraviolet radiation;
(b) providing an electromotive field (EMF); and
(c) performing the reaction in one or more successive chambers;
to produce chlorine dioxide.

2. The method of claim 1, wherein the reaction mixture comprises chlorine gas and oxygen gas.

3. The method of claim 1, wherein the reaction mixture comprises a reactant selected from the group consisting of NaClO₂, NaClO₃, HClO₂, and HClO₃.

4. The method of claim 1, wherein the UV radiation is pulsed intermittently such that there is a pause between two successive pulses.

5. The method of claim 1, wherein the polarized ultraviolet radiation is at least 75% polarized.

6. The method of claim 1, wherein the polarized ultraviolet radiation is at least 95% polarized.

7. The method of claim 1, wherein the polarized ultraviolet radiation includes a wavelength in a range from about 200 nm to about 400 nm.

8. The method of claim 1, wherein the polarized ultraviolet radiation is generated at an intensity of about 1000 mWatts/sq. cm to about 60,000 mWatts/sq. cm.

9. The method of claim 1, wherein the reactants in the reaction chamber is exposed to polarized ultraviolet radiation to about 1 minute to about 60 minutes.

10. The method of claim 1, wherein the chlorine dioxide obtained as a result of the reaction is periodically withdrawn to accelerate formation of chlorine dioxide.

11. The method of claim 1, wherein the chlorine dioxide obtained as a result of the ultraviolet radiation is extracted from the reaction space and introduced into water to form chlorous acid.

12. The method of claim 1, wherein the reaction chamber comprises a coil configuration.

13. The method of claim 1, wherein the EMF is applied through an ultraviolet lamp.

14. The method of claim 1, wherein the EMF is applied through an electrical or magnetic field that is external to the reaction chamber.

15. The method of claim 1, wherein the reaction is accelerated by a stirrer.

16. A method of simultaneously producing chlorine dioxide and sterilizing water, the method comprising:
introducing one or more reactants for chlorine dioxide production into a reaction chamber to form a reaction mixture by exposing to an ultraviolet radiation, wherein the reaction mixture comprises a coextensive coil configuration comprising a first and a second coil; and
simultaneously circulating the water to be sterilized in the second coil such that the chlorine dioxide produced from the first coil in the reaction chamber is introduced in to the second coil.

17. The method of claim 16, wherein the sterilization is also performed by the generation of ozone by circulation of air or oxygen over one or more ultraviolet lamps used for chlorine dioxide production.

18. The method of claim 16, wherein the ultraviolet radiation is polarized.

19. The method of claim 1 or 16, wherein the production of chlorine dioxide is accelerated by reducing scattering of ultraviolet radiation.

20. The method of claim 19, wherein the scattering is reduced by allowing the reactants to settle down in the bottom of the reaction chamber or by continuous stirring of the reaction mixture.

21. A system for chlorine dioxide production comprising:
a reaction chamber comprising one or more successive chambers to receive one or more reactants to form chlorine dioxide;
an ultraviolet radiation source position either within the reaction chamber or adjacent to the reaction chamber;
a polarizer to polarize the ultraviolet radiation, the polarizer positioned to allow the UV radiation from the ultraviolet source to pass through the polarizer; and
an exit member to retrieve the chlorine dioxide produced in the reaction chamber.

22. A system for chlorine dioxide production comprising:
a reaction chamber comprising one or more successive chambers to receive one or more reactants to form chlorine dioxide;
an ultraviolet radiation source positioned either within the reaction chamber or adjacent to the reaction chamber; and
a source for an electromagnetic field to accelerate formation of chlorine dioxide.

23. The system of claims 21 or 22, wherein the reaction chamber comprises a coiled configuration.

24. A device for chlorine dioxide production comprising:
a reaction chamber comprising one or more successive chambers to receive one or more reactants to form chlorine dioxide and the reaction chamber is adjacent to one or more of the following members:
(a) an ultraviolet radiation source positioned either within the reaction chamber or adjacent to the reaction chamber;
(b) a polarizer to polarize the ultraviolet radiation, the polarizer positioned to allow the ultraviolet radiation from the ultraviolet source to pass through the polarizer; and
(c) a source for an electromagnetic field to accelerate the formation of chlorine dioxide.

25. The method of claim 24, wherein the reaction chamber comprises a coil configuration.
